(19) United States
(12) Patent Application Publication
(10) Pub. No.: US 2019/0378028 A1
(43) Pub. Date: Dec. 12, 2019

(54) ACCELERATING MACHINE LEARNING INFERENCE WITH PROBABILISTIC PREDICATES

(71) Applicant: Microsoft Technology Licensing, LLC, Redmond, WA (US)

(72) Inventors: Surajit Chaudhuri, Redmond, WA (US); Srikanth Kandula, Redmond, WA (US); Yao Lu, Seattle, WA (US)

(21) Appl. No.: 16/003,495

(22) Filed: Jun. 8, 2018

(51) Int. Cl. G06N 7/00; G06N 5/04; G06F 17/30

(52) U.S. Cl. CPC G06N 7/005; G06F 17/30554; G06F 17/30442; G06N 5/048

(57) ABSTRACT

Implementations are presented for utilizing probabilistic predicates (PPs) to speed up searches requiring machine learning inferences. One method includes receiving a search query comprising a predicate for filtering blobs in a database utilizing a user-defined-function (UDF). The filtering requiring analysis of the blobs by the UDF to determine blobs that pass the filtering. Further, the method includes determining a PP sequence of PPs based on the predicate. Each PP is a classifier that calculates a PP-blob probability of satisfying a PP clause. The PP sequence defines an expression to combine the PPs. Further, the method includes operations for performing the PP sequence to determine a blob probability that the blob satisfies the expression, determining which blobs meet an accuracy threshold, discarding the blobs with the blob probability less than the accuracy threshold, and executing the database query over the blobs that have not been discarded. The results are then presented.

### TECHNICAL FIELD

The subject matter disclosed herein generally relates to methods, systems, and programs for accelerating complex database queries, and more particularly, for accelerating complex database queries that support machine learning inference tasks.

### BACKGROUND

Some search queries are based on information about the data in a database, but this information is not immediately searchable using standard database queries because the data in the database has to be analyzed to determine if one or more search conditions are met. For example, in a database that stores images, a query may be received to identify images that contain red cars. The relational database does not include a field for a color of the car in images, so the images have to be analyzed to determine if there is a red car within each image.

In some cases, machine learning systems are used to perform the image analysis. However, classic query optimization techniques, including the use of predicate pushdowns, are of limited use for machine learning inference queries because user-defined functions (UDFs) which extract relational columns from unstructured data (e.g., images in the database) are often very expensive and the query predicates may not be able to execute before (or bypass) these UDFs if they require relational columns that are generated by the UDFs.

### BRIEF DESCRIPTION OF THE DRAWINGS

Various ones of the appended drawings merely illustrate example embodiments of the present disclosure and cannot be considered as limiting its scope.

FIG. 1 illustrates the processing of a query that includes the use of machine learning classifiers, according to some example embodiments.

FIG. 2 illustrates the processing of a query utilizing probabilistic predicates (PP), according to some example embodiments.

FIG. 3 is a table showing the cost of using different machine systems, according to some example embodiments.

FIG. 4 illustrates the processing of a query utilizing a query optimizer, according to some example embodiments.

FIG. 5 illustrates the training of probabilistic-predicate machine-learning programs, according to some example embodiments.

FIG. 6 illustrates a query optimizer that utilizes probabilistic predicates, according to some example embodiments.

FIG. 7 illustrates an example illustrating various choices of Probabilistic Predicate (PPs) combinations for a complex predicate, according to some example embodiments.

FIG. 8 is a table showing the complexity of different PP approaches according to dimension-reduction and classifier techniques, for some example embodiments.

FIG. 9 illustrates the functionality of PP classifiers trained using a linear support vector machine or a kernel density estimator, according to some example embodiments.

FIG. 10 illustrates the generation of threshold values corresponding to different accuracy levels, according to some example embodiments.

FIG. 11 illustrates the structure of a fully connected neural network based PP classifier, according to some example embodiments.

FIG. 12 shows the query plan for an OR operation over two PP classifiers, according to some example embodiments.

FIG. 13 shows the query plan for an AND operation over two PP classifiers, according to some example embodiments.

FIG. 14 illustrates an example of the use of a negative PP.

FIG. 15 is a table showing pushdown rules for PPs, according to some example embodiments.

FIG. 16 illustrates a search manager for implementing example embodiments.

FIG. 17 is a flowchart of a method for utilizing probabilistic predicates to speed up searches that utilize machine learning inferences, according to some example embodiments.

FIG. 18 is a block diagram illustrating an example of a machine upon or by which one or more example process embodiments described herein may be implemented or controlled.

### DETAILED DESCRIPTION

Example methods, systems, and computer programs are directed to utilizing probabilistic predicates to speed up searches that utilize machine learning inferences. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Probabilistic predicates (PPs) are binary classifiers configured to filter unstructured inputs by determining if a certain condition is met by each of the inputs. For example, a PP “Is red” is used to analyze an image and determine if the image contains a red object. In some implementations, PPs are utilized to filter data blobs that do not satisfy the predicate of a search query, based on predefined target accuracy levels. Furthermore, several PPs may be used for a given query, and a cost-based query optimizer is used to choose search plans with appropriate combinations of simple PPs. Experiments with several machine learning workloads on a big-data cluster show that query processing may improve by as much as ten times or more.

In one embodiment, a method is provided. The method includes an operation for receiving a query to search a database, the query comprising a predicate for filtering blobs in the database utilizing a user-defined-function (UDF). Further, the filtering requires analysis of the blobs by the UDF to determine if each blob passes the filtering specified by the predicate. In addition, the method includes an operation for determining a PP sequence of one or more PPs based on the predicate, each PP being a binary classifier associated with a respective clause. The PP calculates a PP-blob probability that each blob satisfies the clause, and the PP sequence defines an expression to combine the PPs of the PP sequence based on the predicate. Further, the method includes an operation for performing the PP sequence to determine a blob probability that the blob satisfies the expression, the blob probability based on the PP-blob probabilities and the expression. Additionally, the method includes operations for determining which blobs have a blob probability greater than or equal to an accuracy threshold, discarding from the search the blobs with the blob probability less than the accuracy threshold, executing the database query over the blobs that have not been discarded, the database search utilizing the UDF, and providing results of the database search.

In another embodiment, a system includes a memory comprising instructions and one or more computer processors. The instructions, when executed by the one or more computer processors, cause the one or more computer processors to perform operations comprising: receiving a query to search a database, the query comprising a predicate for filtering blobs in the database utilizing a user-defined-function (UDF), the filtering requiring analysis of the blobs by the UDF to determine if each blob passes the filtering specified by the predicate; determining a PP sequence of one or more probabilistic predicates (PP) based on the predicate, each PP being a binary classifier associated with a respective clause, the PP calculating a PP-blob probability that each blob satisfies the clause, the PP sequence defining an expression to combine the PPs of the PP sequence based on the predicate; performing the PP sequence to determine a blob probability that the blob satisfies the expression, the blob probability based on the PP-blob probabilities and the expression; determining which blobs have a blob probability greater than or equal to an accuracy threshold; discarding from the search the blobs with the blob probability less than the accuracy threshold; executing the database query over the blobs that have not been discarded, the database search utilizing the UDF; and providing results of the database search.

In yet another embodiment, a machine-readable storage medium (e.g., a non-transitory storage medium) includes instructions that, when executed by a machine, cause the machine to perform operations comprising: receiving a query to search a database, the query comprising a predicate for filtering blobs in the database utilizing a user-defined-function (UDF), the filtering requiring analysis of the blobs by the UDF to determine if each blob passes the filtering specified by the predicate; determining a PP sequence of one or more probabilistic predicates (PP) based on the predicate, each PP being a binary classifier associated with a respective clause, the PP calculating a PP-blob probability that each blob satisfies the clause, the PP sequence defining an expression to combine the PPs of the PP sequence based on the predicate; performing the PP sequence to determine a blob probability that the blob satisfies the expression, the blob probability based on the PP-blob probabilities and the expression; determining which blobs have a blob probability greater than or equal to an accuracy threshold; discarding from the search the blobs with the blob probability less than the accuracy threshold; executing the database query over the blobs that have not been discarded, the database search utilizing the UDF; and providing results of the database search.

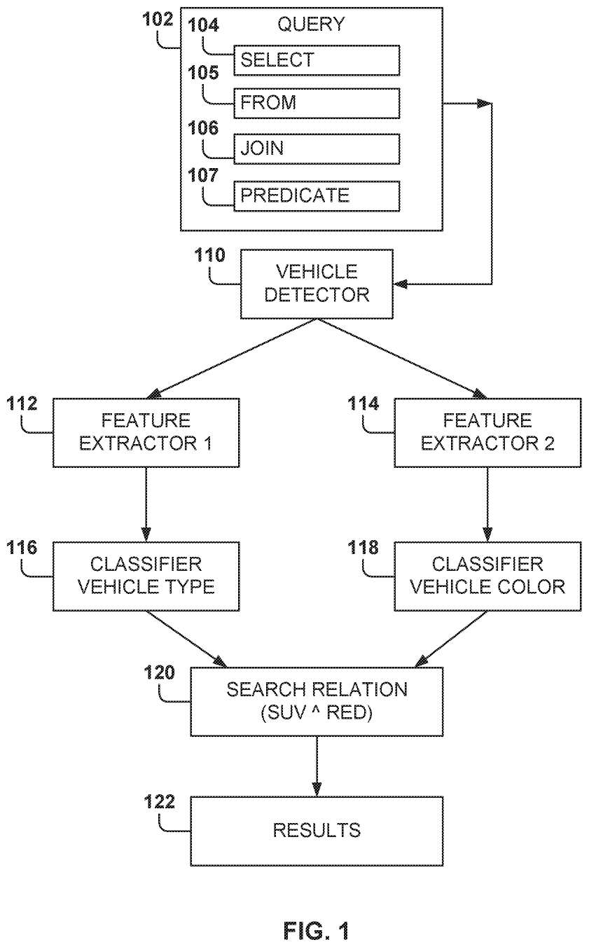

FIG. 1 illustrates the processing of a query that includes the use of machine learning classifiers, according to some example embodiments. Relational data platforms are increasingly being used to analyze data blobs such as unstructured text, images, or videos. As used herein, “blob” (originally derived from Binary Large Object) refers to a block of data that is stored in a database or acquired in a message from a network processor, and it may include an image, a frame of a video, a video, a readable document, etc. Embodiments are presented for blobs that refer to a single image, but other implementations may use the same principles for other types of blobs.

A query 102 in these systems begins by applying user-defined functions (UDFs) to extract relational columns from blobs. A query may include a plurality of elements, such as those elements that may be defined using a database query format, such as Structured Query Language (SQL). The elements may include a select clause 104, a from clause 105, a join clause 106, a predicate clause 107, etc. The predicate clause 107 indicates one or more conditions that the results have to meet; e.g., the predicate clause 107 acts as a data filtering constraint.

For example, a query 102 may be received to find red sport utility vehicles (SUVs) captured by one or more surveillance cameras within a city. The database includes one image frame per row in a relational database, and the query may be expressed as:

| SELECT cameraID, frameID, | |
|---|---|
| (C₁(F₁(vehBox)) AS vehType, C₂(F₂(vehBox)) AS vehColor | |
| FROM | (PROCESS inputVideo |
| | PRODUCE cameraID, frameID, vehBox |
| | USING VehDetector) |

WHERE vehType = SUV Λ vehColor = red;

Here, VehDetector 110, e.g., a machine learning system (MLS), extracts vehicle bounding boxes from each video frame. F₁ and F₂ are feature extractors for extracting relevant features from each bounding box. Further, C₁ and C₂ are classifiers that identify the vehicle type and color using the extracted features.

The goal is to execute such machine learning inference queries efficiently. Existing query optimization techniques, such as predicate pushdown, are not very useful for this example because these techniques do not push predicates below the UDFs that generate the predicate columns. In the above example, vehType and vehColor are available only after VehDetector, C₁, C₂, F₁, and F2 have executed. Even when the predicate has low selectivity (perhaps 1 in 100 images has a red SUV), every video frame has to be processed by all the UDFs.

Using an existing query optimization technique would first utilize the MLS VehDetector to determine if there are vehicles in the blob and the fine bounding boxes for each found vehicle. If vehicles are identified, feature extractors F₁ 112 and F₂ 114 are used to extract the relevant features from each bounding box. Afterwards, classifiers C₁ 116 and C₂ 118 are used to determine the vehicle type and the color of the vehicle.

Further, the predicate clause 107 is applied 120 to the found vehicles to determine if each blob includes a vehicle type of SUV and a vehicle color of red. Results 122 that satisfy the predicate are then returned.

It may be possible to simplify the problem by separating the machine-learning components from the relational portion (e.g., access columns that are already in the database or the network message). For example, some component exogenous to the data platform may pre-process the blobs and materialize all the necessary columns (e.g., create a column with a Boolean value for “Is red”), and a traditional query optimizer may then be applied to the remaining query. This approach may be feasible in certain cases but is, in general, infeasible. In many workloads, the queries are complex and use many different types of feature extractors and classifiers. Thus, pre-computing all possible predicate options would be extremely expensive in terms of computational and storage resources. Moreover, pre-computing would be wasteful for ad-hoc queries since many of the columns with extracted features may never be used.

In surveillance scenarios, for example, ad-hoc queries typically obtain retroactive video evidence for traffic incidents. While some videos and columns may be accessed by many queries, some may not be accessed at all. Finally, for online queries (e.g., queries on live newscasts or broadcast games), it may be faster to execute the queries and machine learning (ML) components directly on the live data.

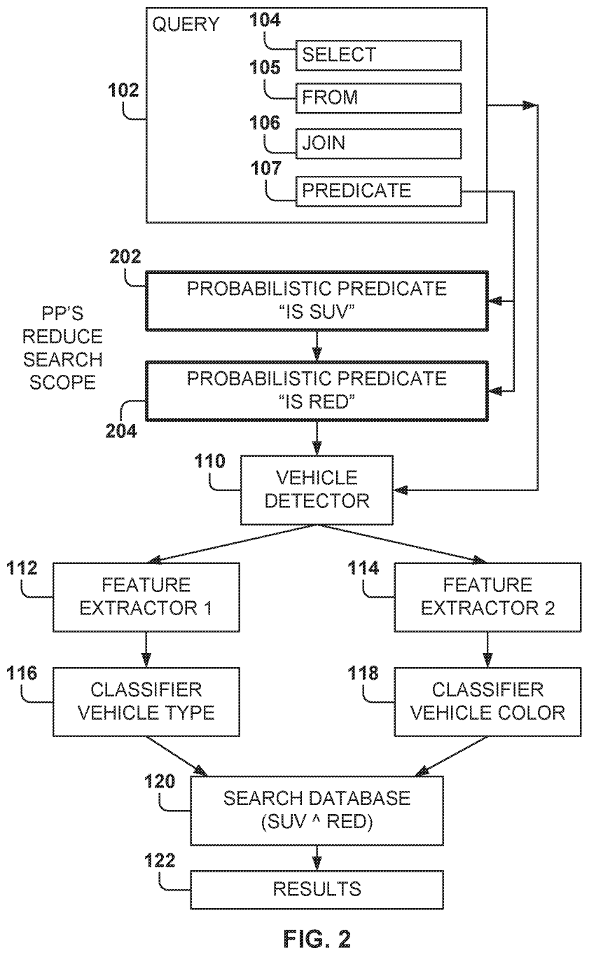

FIG. 2 illustrates the processing of a query utilizing probabilistic predicates, according to some example embodiments. At a high level, the PPs act as predicates for the non-relational data, e.g., act as filters on non-relational data. In some example embodiments, the PP is a classifier for one term of the predicate that executes on the blobs, dropping blobs that do not meet the condition associated with the PP.

In some example embodiments, the PP operates on the whole blob. Thus, the PP does not take into consideration the features identified by the feature extractors, such as the bounding boxes, because the PP is applied before the other terms in the query. The one or more PPs are applied first to the input blobs in order to discard some of the blobs that do not meet the associated conditions, and then the search operations of the query 102 are performed on the remainder of the blobs.

In the example illustrated in FIG. 2, two PPs have been identified, and the search plan has identified a PP 202 “Is SUV” to be executed before a PP 204 “Is red.” Therefore, the PP 202 is executed first, the blobs that satisfy the condition “Is SUV” are used as input to the PP 204, and the blobs that do not satisfy the condition are discarded.

After the PP 204 is applied, the blobs that meet the condition are used as input to the vehicle detector 110, and the blobs that do not meet the condition are discarded. Therefore, the remainder of the operations may be performed with a much smaller subset of data than if the PPs are not utilized, as illustrated in FIG. 1.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised, indicating a decreasing level to which the “correct” outputs are provided in correspondence to the training inputs. In a supervised learning phase, all of the outputs are provided to the model, and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

A classifier is a machine-learning algorithm designed for assigning a category for a given input, such as recognizing a face of an individual in an image. Each category is referred to as a class, and, in this example, each individual who may be recognized constitutes a class (which includes all the images of the individual). The classes may also be referred to as labels. Although embodiments presented herein are presented with reference to object recognition, the same principles may be applied to train machine-learning programs used for recognizing any type of items.

One goal is to accelerate machine learning inference queries with expensive UDFs by using probabilistic predicates. In some example embodiments, each PP is a “simple” classifier aimed at consuming few resources while discarding a large number of blobs. By “simple,” it is meant that the classifier filters for a condition that is easy to evaluate, such as “Is red,” which means that there is a red object in the image; “Is there a dog in the image”; “Is the word ‘attack’ in the document”; etc. A more complex classifier may perform a much finer selection, such as identifying a celebrity from a large number of possible persons, determining if there is a green car going at more than sixty miles an hour on a highway, determining whether the document is about fake news, etc. These complex classifiers require more complex training data, evaluation of a larger number of features, and more computational resources.

In general, the PP classifiers have a trade-off between accuracy and performance, whereas previously the predicates may not have had a trade-off. Additionally, a cost is associated with executing the PP as, generally speaking, more complex PPs require higher execution costs. In some cases, it may be better to use a first PP that is not as accurate (e.g., discriminating) as a second PP, if the first PP costs less to execute. In other cases, the second PP may be better for the application in order to meet an accuracy goal.

A decision made by the system designer is what PPs should be built in order to speed up as many queries as possible. In some large systems, the number of possible query predicates may be very large (e.g., one per query), so constructing all the possible PPs is not practical. For example, a PP could be built for “Is dog AND is puppy AND is black.” but this particular PP may be used very infrequently.

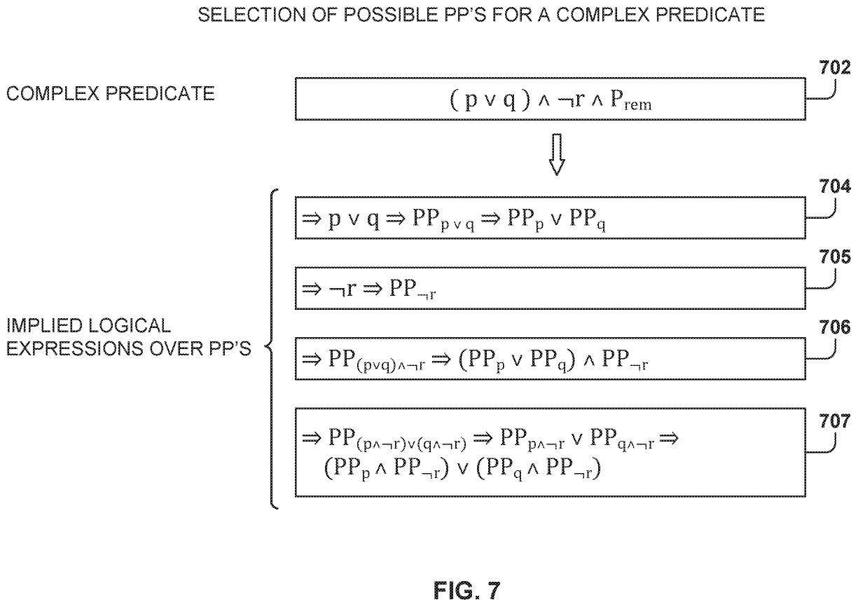

In some example embodiments, the PPs are created for checking a single condition, and then several PPs may be combined to account for complex predicates. More details are provided below with reference to FIG. 7 on how to combine PPs. Of course, in some cases, more complex PPs may be created that check for complex conditions if this type of complex PP is expected to be used often.

In some example embodiments, an analysis is made of the search queries received over a period of time to identify the most common conditions in the predicates. The system designer may then create the PPs for the most common conditions.

In some example embodiments, the PPs are binary classifiers on the unstructured input which shortcut the subsequent UDFs for those data blobs that will not pass the query predicate, thereby reducing the query cost. For example, if the query predicate, has red SUVs, has a small selectivity and the PP is able to discard half of the frames that do not have red SUVs, the query may speed up by two times or more.

Furthermore, conventional predicate pushdown produces deterministic filtering results, but filtering with PPs is parametric over a precision-recall curve. Different filtering rates (and hence speed-ups) are achievable based on the desired accuracy.

It is to be noted that machine learning queries are inherently tolerant of error because even the unmodified queries have machine learning UDFs with some false positives and false negatives. In some cases, injecting PPs does not change the false positive rate but may increase the false negative rate. In some implementations, a method is used to bound the query-wide accuracy loss by choosing which PPs to use and how to combine them. Experiments have shown sizable speed-ups with negligibly small accuracy loss on a variety of queries and datasets.

Different techniques to construct PPs are appropriate for different inputs and predicates (e.g., based on input sparsity, the number of dimensions, and whether the subsets of input that pass and fail the predicate are linearly separable). In some implementations, different PP construction techniques (e.g., linear support vector machines (SVMs), kernel density estimators, neural networks (NNs)) are used to select an appropriate execution plan that has high execution efficiency, a high data reduction rate, and a low number of false negatives.

Further, query optimization techniques can be used to support complex predicates and ad-hoc queries with only a small number of available PPs. For example, PPs that correspond to necessary conditions of the query predicate may be integrated into queries that have selects, projects, and foreign-key joins. These techniques reduce the number of PPs that have to be trained.

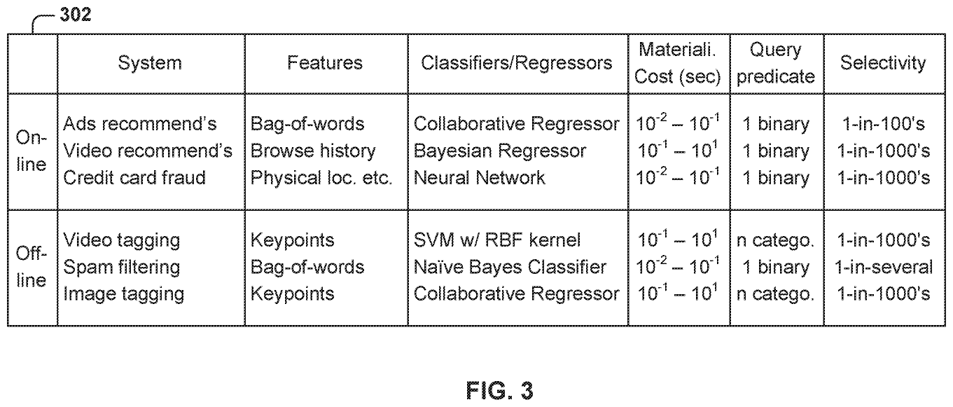

FIG. 3 is a table 302 showing the cost of using different machine systems, according to some example embodiments. Table 302 illustrates some example applications.

The problem of querying non-relational input such as videos, audios, images, unstructured text, etc. is crucial to many applications and services. Regarding the analysis of surveillance video, there have been city-wide deployments in many cities with hundreds or thousands of cameras. Also, there has been a great increase in body cameras worn by police and security cameras deployed at homes.

The following are some example inference queries:

Q1: Find cars with speed ≥80 mph on a highway.

Q2: What is the average car volume on each lane of a highway?

Q3: Find a black SUV with license plate ABC123.

Q4: Find cars seen in camera C1 and then in camera C2.

Q5: Send text to phone if any external door is opened.

Q6: Alert police control room if shots are fired.

To answer such queries, multiple machine learning UDFs, such as feature extractors, classifiers, etc., are applied to the input (e.g., video frames captured by cameras). The subsequent row-sets are filtered, sometimes implicitly (e.g., video frames without vehicles are dropped in Q2).

Further, queries may also contain grouping, aggregation (e.g., Q2), and joins (e.g., Q4). It is easy to observe that the materialization cost (e.g., time and resources used to execute the machine learning UDFs) will be high in processing these queries. It is also easy to see that materialization is query-specific. While there is some commonality, in general, different queries invoke different feature extractors, regressors, classifiers, etc.

Considering all the possible queries that may be supported by a system, the number of distinct UDFs on the input is vast. Hence, a priori application of all UDFs on the input has a high resource cost. Security alerts, such as Q5 and Q6, are time-sensitive and Q2 may be executed online to update driving directions or to vary the toll price of express lanes in real time. For such latency-sensitive queries, a priori application of all UDFs on the input can add an excessive amount of delay.

Beyond surveillance analytics, many applications share the above three aspects: large materialization cost, diverse body of machine learning UDFs, and latency and/or cost sensitivity. Table 302 illustrates some of these applications. The applications may be online (ad recommendations, video recommendations, credit card fraud) or offline (video tagging, spam filtering, and image tagging). Each of the different applications might utilize different features, such as bag of words, browsing history, physical location, etc. Table 302 further shows some examples of classifiers or regressors that may be utilized with an expected cost, type of query predicate, and expected selectivity.

The materialization cost in these systems ranges from milliseconds to seconds per input data item, which can be significant when millions of data blobs are generated in a short period of time, e.g., in a video streaming system. Since queries may use many different UDFs, offline systems would need large amounts of compute and storage resources to pre-materialize the outputs of all possible UDFs. Online systems which often require rapid responses can also become bottlenecked by the latency to pre-materialize UDFs.

To reduce the execution cost and latency of the machine learning queries, suppose that a filter may be applied directly to the raw input which discards input data that will not pass the original query predicate. Cost decreases because the UDFs following the filter only have to process inputs that pass the filter. A higher data reduction rate r of the filter leads to a larger possible performance improvement. The data reduction rate r refers to the percentage of data inputs that may be eliminated by the filter.

Let the cost of applying the filter be c and the cost of applying the UDF be u; then the gain g from early filtering will be:

$$g = \frac{1}{1 - r + ( c / u )} \qquad ( 1 )$$

The more efficient the early filter is relative to the UDFs (small c/u), the larger the gain g will be. Moreover, the query performance can become worse (instead of improving) if r≤c/u, e.g., the early filter has a smaller data reduction relative to its additional cost. Therefore, only filters that have a large r will speed up the query.

Another consideration is the accuracy of the early filter. Since the original UDFs and query predicate will process input that is passed by the early filter, the false positive rate of the query is unaffected. However, the filter may drop input data that would pass the original query predicate, and thus can increase false negatives. Unlike queries on relational data, machine learning applications have an in-built tolerance for error since the original UDFs in the query also have some false positive and false negative rate. Therefore, it is feasible to ask the users to specify a desired accuracy threshold a. In some queries, such as Q1 and Q2, a known amount of inaccuracy is tolerable to the user.

To achieve sizable query speed-up with desired accuracy, some challenges have to be solved. A first challenge is how to construct these early filters. Since the raw input does not have the columns required by the original query predicate, constructing early filters is not akin to predicate pushdown and is not the same as ordering predicates based on their cost and data reduction r. In some example embodiments, binary classifiers are trained, where the binary classifiers group the input blobs into those that disagree and those that may agree with the query predicate. The input blobs that disagree are discarded, and the remainder are passed through to the original query plan. These classifiers are the aforementioned probabilistic predicates, because each PP has associated values for the tuple [data reduction rate, cost, accuracy]. It is possible to train PPs with different tuple values.

A second challenge is how to construct PPs that are useful. e.g., PPs that have a good trade-off between data reduction rate, cost, and accuracy. Success in partitioning the data into two classes, a class that passes the original query predicate and another class that does not pass, depends on the underlying data distributions. A predicate can be thought of as a decision boundary separating the two classes. Intuitively, any classifier that can identify inputs far away from this decision boundary can be a useful PP. However, the nature of the inputs and the decision boundary affects which classifiers are effective at separating the two classes. In some example embodiments, different classifiers are utilized, such as linear support vector machines (SVMs) for linearly separable cases, and kernel density estimators (KDEs) and neural networks for non-linearly separable cases. However, other classifiers may also be utilized for constructing the PPs.

To handle data blobs with high dimensionality, implementations utilize sampling, principal component analysis (PCA), and feature hashing. A model selection process is applied to choose appropriate classification and dimensionality reduction techniques.

A third challenge is how to support complex predicates and ad-hoc queries. Since query predicates can be diverse, trivially constructing a PP for each query is unlikely to scale. In the example of FIG. 2, a PP trained for red∧SUV cannot be applied to (red∧car) or (blue∧SUV). In some implementations, PPs per simple clauses are built, and the query optimizer, at query compilation time, assembles an appropriate combination of PPs that (1) has the lowest cost, (2) is within the accuracy target, and (3) is semantically implied by the original query predicate. e.g., is a necessary condition of the query predicate (since we use PPs to drop blobs that are unlikely to satisfy the predicate).

In some example embodiments, PPs are built for clauses of the form ƒ(gᵢ(b), . . . )ϕv, where ƒ and gᵢ are functions; b is an input blob; ϕ is an operator that can be any of =, ≠, <, ≤, >, ≥; and v is a constant. Using these PPs, the Query Optimizer (QO) can support predicates that contain arbitrary conjunctions, disjunctions, or negations of the above clauses.

The basic intuition behind probabilistic predicates is akin to that of cascading classifiers in machine learning: a more efficient but inaccurate classifier can be used in front of an expensive classifier to lower the overall cost. Typical cascades, however, use classifiers that have equivalent functionality (e.g., all are object detectors). In contrast, PPs are not equivalent to the UDFs that they bypass. Further, agnostic to the functionality of the UDFs that are bypassed, PPs are binary predicate-specific classifiers. Without this specialization (reduction in functionality), it may be difficult to obtain a classifier that executes over raw input and still achieves good data reduction without losing accuracy. Furthermore, typical cascades accept and reject input anywhere in the pipeline. While this could work for selection queries whose output is simply a subset of the input, it will not easily extend to queries having projections, joins, or aggregations. In general, the PPs apply directly to an input and reject irrelevant blobs, and the rest of the input is passed to the actual query.

Embodiments presented herein illustrate how to identify and build useful PP classifiers and how to provide deep integration between the PP classifiers and the QO. The former involves careful model selection, and the latter generalizes applicability to complex predicates and ad-hoc queries. Further, a related system identifies correlations between input columns and a user-defined predicate and then learns a probabilistic selection method which accepts or rejects inputs, based on the value of the identified correlated input columns, without evaluating the user-defined predicate.

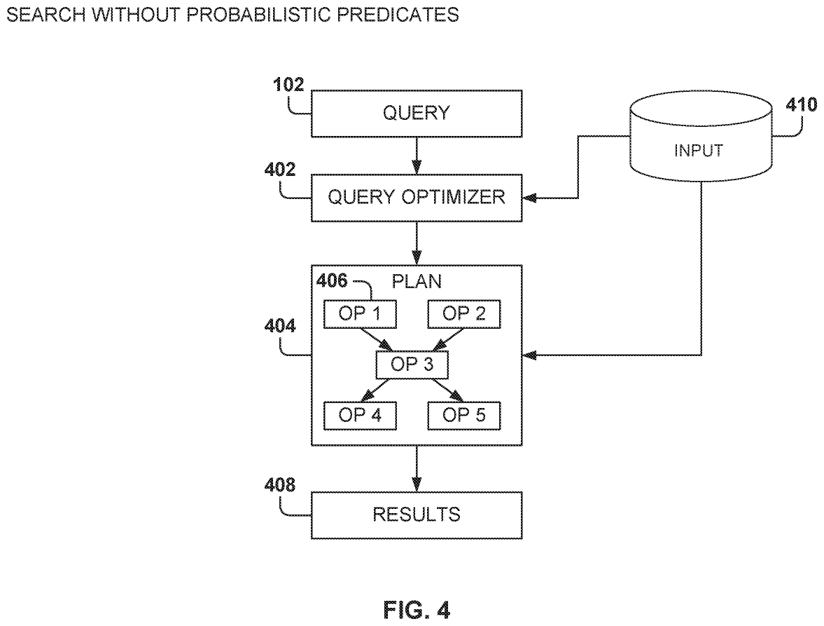

FIG. 4 illustrates the processing of a query utilizing a query optimizer 402, according to some example embodiments. In some example embodiments, a query language offers some new templates for UDFs. A developer may implement a UDF by inheriting from the appropriate UDF template. A processor template encapsulates row manipulators that produce one or more output rows per input row. Processors are typically used to ingest data and perform per-blob ML operations such as feature extraction. Further, reducers encapsulate operations over groups of related items. Context-based ML operations, such as object tracking which uses an ordered sequence of frames from a camera, are built as reducers. On the query plan, reducers may translate to a partition-shuffle aggregate.

Combiners encapsulate custom joins, that is, operations over multiple groups of related items. Similar to a join, combiners may be implemented in several ways, e.g., as a broadcast join, a hash join, etc.

FIG. 4 illustrates an example for processing a query without PPs. A query 102 is received by the query optimizer 402, and the query optimizer 402 generates a plan 404 for accessing input 410, which includes the data stored in the database. For example, the input 410 may include a sequence of blobs that are stored in a database.

The query 102 may include one or more UDFs. and the query optimizer 402 generates the plan 404 to efficiently access the input 410 data to retrieve the desired results. The plan 404 includes one or more data-access operations (e.g., operation 1) 406 for retrieving data, and these operations may be performed sequentially, in parallel, or a combination thereof. When executed, the operations 406 of the plan 404 generate the desired results 408.

Four case studies were analyzed during experimental evaluations: document analysis, image analysis, video activity recognition, and comprehensive traffic surveillance. The input datasets have numbers of dimensions ranging from thousands (e.g., low-resolution images) to hundreds of thousands (e.g., bag-of-words representations of documents which can be very sparse). Some predicates may be correlated (e.g., hierarchical labels of documents and activity types in videos). Further, the selectivity of predicates also varies widely, where some predicates have very low selectivity (e.g., “Has truck” in a traffic video) and others may have high selectivity.

A first use case relates to document analysis. The Large Scale Hierarchical Text Classification (LSHTC) dataset contains 2.4M documents from Wikipedia, and each document is represented as a bag of words with a frequency value for each of 244K words, which results in a vector that is sparse.

A second use case relates to image labeling. The SUNAttribute dataset contains 14K images of various scenes, and the images are annotated with 802 binary attributes that describe the scene, such as “Is kitchen,” “Is office,” “Is clean,” “Is empty,” etc. Queries that retrieve images having one or more attributes were considered for PPs.

A third use case relates to video activity recognition. The UCF 101 video activity recognition dataset (a dataset of 101 human actions classes from videos in the wild) was utilized, which has 13K video clips with durations ranging from ten seconds to a few minutes. Each video clip is annotated with one of 101 action categories such as “Applying lipstick,” “Rowing,” etc. The problem of retrieving clips that illustrate an activity was analyzed.

The fourth use case relates to comprehensive traffic surveillance video analytics. The problem of answering comprehensive queries on traffic surveillance videos was analyzed. The datasets include hours of surveillance videos from the DETRAC (DETection and tRACking) vehicle detection and tracking benchmark. A query set was designed to perform machine learning actions such as vehicle detection, color and type classification, traffic flow estimation (vehicle speed and flow), etc. While DETRAC already annotates vehicles by their types (sedan, SUV, truck, and van/bus), the vehicle color was manually annotated (red, black, white, silver, and other).

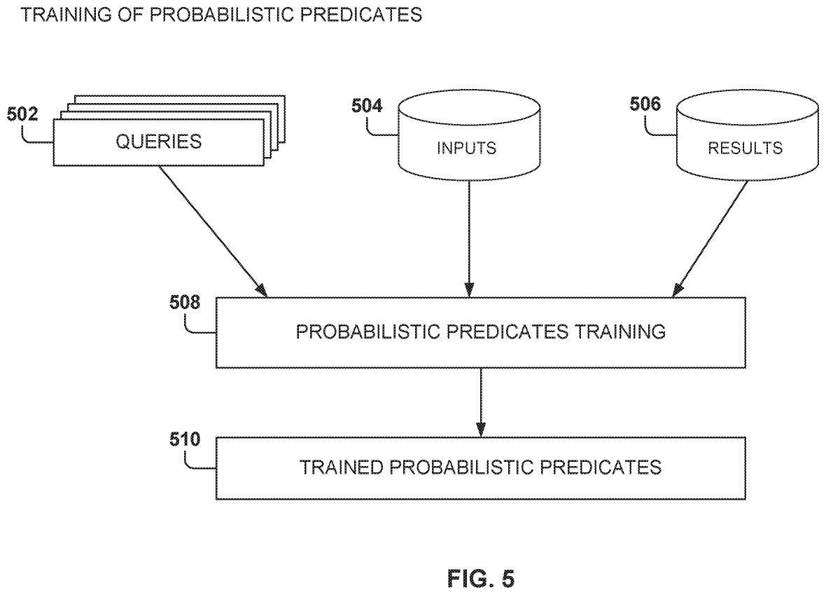

FIG. 5 illustrates the training of probabilistic-predicate machine-learning programs, according to some example embodiments. In some example embodiments, the PP training utilizes binary labeled input data 504; e.g., the labels specify whether an input blob passes or fails the predicate. The output of applying a PP is an identification of the PP annotated with the predicate clause that it corresponds to, the cost of execution, and the predicted data reduction vs. accuracy.

In some example embodiments, historical queries 502, in a batch system, are utilized to infer the simple clauses that appear frequently in the queries. To train 508 probabilistic predicates for these PP conditions, some labeled input data may already be available because a similar corpus was used to build the original UDFs (e.g., training the classifiers). Alternatively, the labeled corpus may be generated by annotating the query plans; e.g., the first query to use a certain clause will output labeled input in addition to query results 506.

In an online system, the training process may run contemporaneously with the query execution. That is, at a cold start when no PP is available, the query plans output labeled inputs for relevant clauses. Periodically, or when enough labeled input is available, the PPs are trained 508, and subsequent runs of the query may use query plans that include the trained PPs 510.

The details of how to train the individual PPs are now presented. In some example embodiments, a PPₚ for a predicate clause p is uniquely characterized by the following triple:

PPₚ={ [symbol] ,m,r[a]} (2)

Here, [symbol] is the training dataset that includes the portion of data blobs on which PPₚ is constructed. Each blob x∈ [symbol] has an associated label l(x), which has a value of +1 for blobs that agree with p, and −1 for those blobs that disagree with p. Further, m is the filtering strategy picked by the model selection scheme, indicating which classification ƒ(⋅) and dimension-reduction ψ(⋅) algorithms to use.

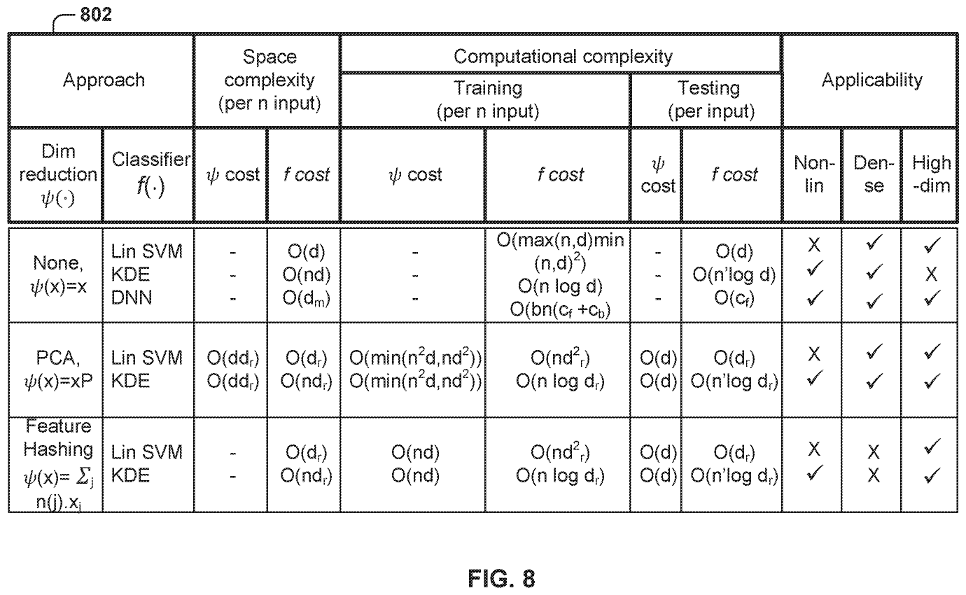

The costs of the PP for different approaches are described in a table 802 of FIG. 8. Further, r[a] is the data reduction rate, which is the portion of data blobs filtered by PPₚ given the above settings, and a is the target accuracy, where a∈[0, 1] (e.g., 1.0, 0.95). The PPs are parametrized with a target accuracy level.

A first classifier is a linear support vector machine (SVM), which is a binary classifier. The linear SVM has the form:

ƒₗₛᵥₘ(ψ(x))=w^{T}·ψ(x)+b, (3)

Here, ψ(x) denotes a dimension-reduction technique to project the input blob x onto fewer dimensions (different dimension-reduction techniques are discussed below). Further, w is a weight matrix and b is a bias term, and both of them are trained so that ƒ(⋅) is close to the labels l(⋅) of the blobs in the training set [symbol] .

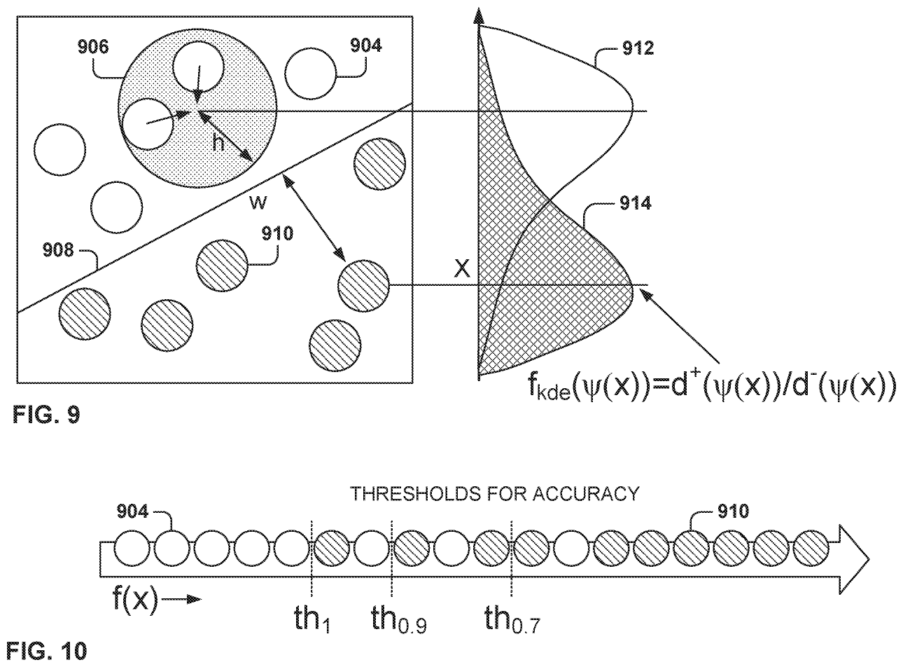

Equation (3) may be interpreted as a hyperplane that separates the labeled inputs into two classes as shown in FIG. 9. Perfect separation between the classes may not always be possible; therefore, the following decision function is used to predict the labels:

$$PP ( x ) = \{ \begin{matrix}+ 1 & if f ( ψ ( x ) ) > th [ a ] \\ - 1 & otherwise\end{matrix} \qquad ( 4 )$$

Here, th[a] is the decision threshold under the desired filtering accuracy a. Different values of th[a] will produce different accuracy and reduction ratios. For example, when th[a] is −∞, all blobs will be predicted to pass the predicate (PP(x)=+1), leading to a reduction ratio of 0 and a perfect accuracy a=1.

In some example embodiments, the parametric threshold th[a] is chosen as follows:

$$th [ a ] = max th s . t . \frac{\vert \{ x ϵ 𝒟 : f ( ψ ( x ) ) > th \} \vert}{\vert \{ x ϵ 𝒟 : 𝓁 ( x ) = + 1 \} \vert} \geq a \qquad ( 5 )$$

It is to be noted that since the decision function is deterministic regardless of the th[a] value, a PP parametrized for different accuracy thresholds can be built without retraining the SVM classifier. FIG. 10 illustrates some examples for choosing th[a], wherein the white circles 904 represent −1 and the shaded circles 910 represent +1.

Further, the reduction ratio r achieved by the PP may be calculated as follows:

$$r [ a ] = 1 - \frac{\vert \{ x ϵ 𝒟 : f ( ψ ( x ) ) > th [ a ] \} \vert}{\vert 𝒟 \vert} \geq a \qquad ( 6 )$$

It is to be noted that linear SVMs have pros and cons. Linear SVMs may be trained efficiently (see the table 802 in FIG. 8) and have a small cost of testing. However, linear SVMs yield a poor PP if the input blobs are not linearly separable; i.e., in such case, meeting the desired filtering accuracy results in a small data reduction.

In other example embodiments, non-linear SVM kernels (e.g., Radial Basis Function (RBF) kernel) may be used. However, the computational complexity of these non-linear SVM kernels may significantly increase for both training and inference.

An alternative classification method for non-linearly separable problems is kernel density estimation (KDE). Machine learning blobs, such as images and videos, may be high dimensional and not always linearly separable. For these cases, a nonparametric PP classifier may be constructed that does not assume any underlying data distribution. Intuitively, a set of labeled blobs can be translated into a density function such that the density at any location x indicates the likelihood of its belonging to the set.

Consider the density functions in FIG. 9. Two density functions for the blobs in the training set are calculated according to their labels. Further, d⁺(ψ(x)) and d⁻(ψ(x)) are the density (e.g., likelihood) that ψ(x) has a +1 or −1 label, respectively. As shown in FIG. 9, the density functions may overlap.

As before, Φ(x) denotes a dimension-reduction technique. The kernel density estimator ƒ_{kde}(ψ(x)) is defined as follows:

ƒ_{kde}(ψ(x))=d⁺(ψx))/d⁻(ψ(x)) (7)

Intuitively, data points x with a true label of +1 should have a higher value on d⁺(ψ(x)) than d⁻(ψ(x)), leading to a high ƒ_{kde} value. Similarly, if x has a true label of −1, ƒ_{kde} should be low.

To build the density functions d⁺ and d⁻, KDE is utilized. The density d⁺(ψ(x)) of points with +1 labels is defined as follows:

$${d}_{h}^{+} ( ψ ( x ) ) = {\sum }_{i = o , {𝓁}_{i} = + 1}^{n} K ( \frac{ψ ( x ) - ψ ( {x}_{i} )}{h} ) \qquad ( 8 )$$

Here, h is a fixed parameter indicating the size of ψ(x)'s neighborhood that should be examined, and K is the kernel function to normalize ψ(x)'s neighborhood. A Gaussian kernel, which yields smooth density estimations, is used.

Further, d⁻(ψ(x)) is defined similarly over data blobs having −1 labels. Cross-validation is used to choose h. Further, Silverman's rule of thumb (see Bernard W. Silverman. Density estimation for statistics and data analysis) may also be used to pick an initial h.

To complete the construction of the probabilistic predicate using the KDE method, equations (4)-(6) can be applied by using ƒ_{kde} in place of ƒₗₛᵥₘ. In particular, like the linear SVM PP, the KDE PP may be parametrized without retraining the classifier.

It is to be noted that PPs using the KDE method are effective even when the underlying data is not linearly separable. However, this comes with some additional cost during testing, as illustrated in the table 802 of FIG. 8. In particular, applying the KDE PP at test time may require a pass through the entire training set because the densities d⁺ and d⁻ are computed based on the distance between the test point x and each of the training points. To avoid this, a k-d tree is used, a data structure that partitions the data by its dimensions. Similar data points are assigned to the same or nearby tree nodes. With a k-d tree, the density of an input blob x is approximately computed by applying equation (8) to ψ(x)'s neighbors retrieved from the k-d tree (e.g., n′ nodes as shown in the table 802, where n′<<n, the number of training samples). The retrieval complexity is, on average, logarithmic in the feature length of the input blob. A third classifier that may be used is a deep neural network (DNN).

Principal component analysis (PCA) is a technique for dimension reduction. The input x is projected using ψ(x)=xP, where P is the linear basis extracted from the training data.

There are two considerations. First, even when the underlying data is not linearly separable, applying PCA does not prevent the subsequent classifier from identifying blobs that are away from the decision boundary. Second, computing the PCA basis using singular value decomposition is quadratic in either the number of blobs in the training set or in the number of dimensions O(min(n²d, nd²)). To speed up the process, PCA is computed over a small sampled subset of the training data [symbol] , in order to trade off reduction rate for speed. The formulas in the table 802 may be used to determine the costs of using PCA during training and test, where n can be either the full training set or the sampled subset.

Feature hashing (FH) is another dimension-reduction technique which can be thought of as a simplified form of PCA that requires no training and is well suited for sparse features. It uses two hash functions h and η as follows:

∀i=1 . . . dᵣ, ψᵢ^{(h,η)}(x)=Σⱼ₌₁^{d}1ₕ₍ⱼ₎₌ᵢ·η(j)xⱼ (9)

Here, the first hash function h(⋅) projects each original dimension index (j=1, . . . , d) into exactly one of dᵣ dimensions, and the second hash function η(⋅) projects each original dimension index into ±1, indicating the sign of that feature value. Thus, the feature vector is reduced from d to dᵣ dimensions. It can be seen that feature hashing is inexpensive, and it has been shown to be unbiased. However, if the input feature vector is dense, hash collisions are frequent and classifier accuracy worsens.

Further, to avoid overfitting on the training data, the input set of blobs [symbol] is randomly divided into training and validation portions. The classifiers are trained using the training portion [symbol] ₜᵣₐᵢₙ, but the accuracy-data reduction curve r[a] is calculated on the validation portion [symbol] ᵥₐₗ. Furthermore, a check is made to determine that the trained classifier has an accuracy almost as good as predicted on the validation portion.

Further, classifiers built for a PP on predicate p can be reused for the PP on predicate ¬p (NOT p). Given the classifier functions (e.g., ƒₗₛᵥₘ,ƒ_{kde}) built for a predicate p, multiplying these functions by −1 yields the corresponding classifier functions for predicate ¬p. Therefore, the PP for predicate ¬p can reuse the classifier and compute equations (5) and (6) with −1*ƒ instead.

Further, the input feature to the PP is a representation of the data blob, e.g., raw pixels for images, concatenations of raw pixels over consecutive frames (of equal duration) for videos, and tokenized word vectors for documents.

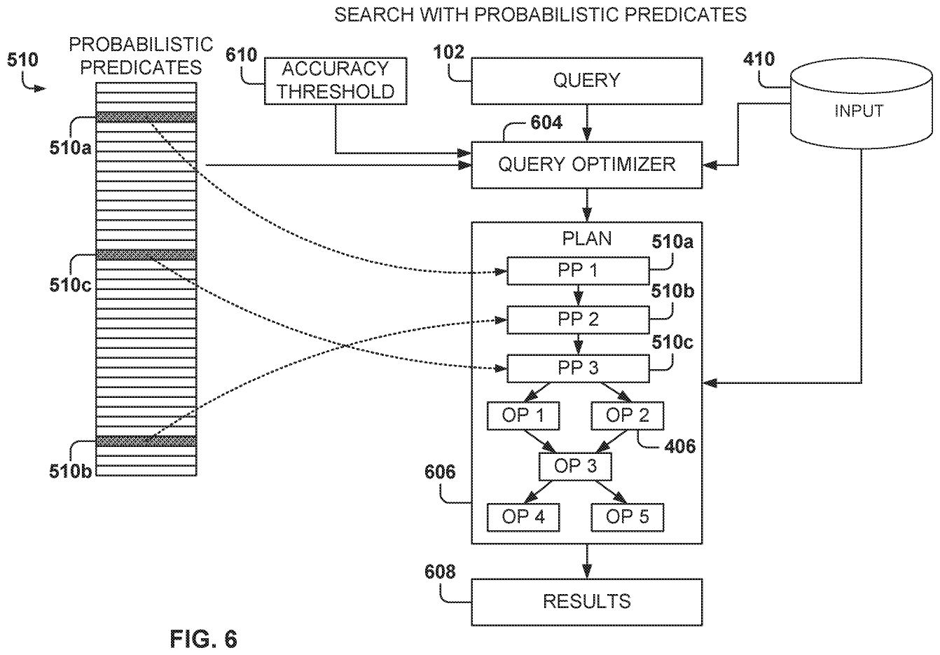

FIG. 6 illustrates a query optimizer 604 that utilizes probabilistic predicates, according to some example embodiments. The query optimizer 604 takes, in addition to the query 102 and the input 410 database, two additional inputs: available trained PPs 510 and a desired accuracy threshold 610 for the query.

The query optimizer 604 adds appropriate combinations of PPs (e.g., 510a-510c) for each query to a plan 606, based on the accuracy threshold 610. Once the plan 606 is being executed, the selected PPs are executed on the raw input 410 before the remaining operations 406 associated with the query, which are semantically equivalent to the original query plan without PPs. After the plan 606 is executed, results 608 are returned.

FIG. 7 illustrates an example illustrating various choices of Probabilistic Predicate (PPs) combinations for a complex predicate, according to some example embodiments. A first goal for the query optimizer is to determine which PPs may be useful for a query with a complex predicate or a previously unseen predicate.

A query can use any available PP or combination of available PPs that is a necessary condition to the actual predicate. Given a complex query predicate [symbol] , the QO generates zero or more logical expressions [symbol] that are equivalent or necessary conditions for [symbol] but only contain conjunctions or disjunctions over simple clauses: that is [symbol] ⇒ [symbol] . The challenge is that there may be many choices of [symbol] ; therefore, the exploration of choices has to be quick and effective.

A second goal for the QO is to pick the best implementation over the available expressions over PPs while meeting the query's accuracy threshold. For individual PPs, their training already yields a cost estimate and the accuracy vs. the data reduction curve. The challenge is to generate these estimates for logical expressions over PPs. The QO explores different orderings of the PPs within an expression [symbol] and explores different assignments of accuracy to each PP, which ensures that the overall expression meets the query-level accuracy threshold. The QO outputs a query plan with the chosen implementation.

For example, consider a complex predicate 702 of the form:

[symbol]

=(p∨q)∧¬r∧ [symbol] ᵣₑₘ (10)

Here, p, q, and r are simple clauses for which PPs have been trained, and [symbol] ᵣₑₘ is the remainder of the predicate. Each PP is uniquely characterized in part by the simple clause that it mimics, where PPₚ is the PP corresponding to the simple clause p.

Some possible expressions 704-707 over PPs may be used to support this complex predicate. It is to be noted that some parts of [symbol] , such as [symbol] ᵣₑₘ in this example, that are attached by ∧(AND) can be ignored since PPs corresponding to the other parts will be necessary conditions for [symbol] . Further, when the predicate has a conjunction over simple clauses, PPs for one or more of these clauses can be used. This is illustrated in expressions 704 and 705.

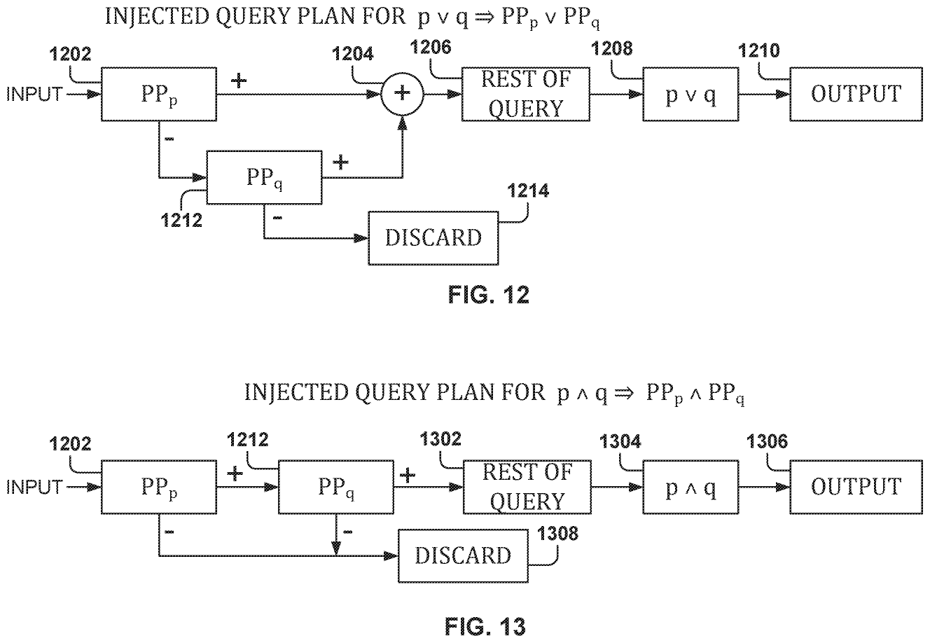

Further yet, a disjunction of two PPs (e.g., PPₚ∨PP_{q}) is a valid PP for the disjunction p∨q. The proof is described below with reference to FIG. 12. The blobs that do not pass both the PPs will be discarded. As before, there will be no false positives since the actual predicate applies to the passed blobs, but there may be some false negatives. A similar proof holds for a conjunction as well, as described below with reference to FIG. 13.

Expressions 704 and 706 show the use of the disjunction and conjunction rewrite respectively. Such rewrites substantially expand the usefulness of PPs because otherwise PPs would need to be trained, not just for individual simple clauses, but for all combinations of simple clauses.

Further, the predicate can also be rewritten logically, leading to more possibilities for matching with PPs. For example, the expression (p∨q)∧¬r⇔(p∧¬r)∨(q∧¬r) leads to the PP expressions 706 and 707.

It is to be noted that the number of implied expressions over PPs that correspond to a complex predicate may be substantial, and FIG. 7 illustrates a few of the possibilities.

Thus, expression 704 illustrates that an OR expression p∨q may result in a PP_{p∨q} for the OR expression or the combination of two PPs, PPₚ for p and PP_{q} for q.

Further, expression 705 illustrates that a negative (¬r) may result in the corresponding PP_{¬r}.

Expression 706 illustrates the result of combining expressions 704 and 705 plus breaking down the conjunction ∧ operation. Thus, PP_{(p∨q)∧¬r} may be broken into (PPₚ∨PP_{q})∧PP_{¬r}.

Further, expression 707 illustrates that PP_{(p∨q)∨(q∨¬r)} may be decomposed into PP_{p∧¬r}∨PP_{q∧¬r}, which results in (PPₚ∧PP_{¬r})∨(PP_{q}∧PP_{¬r}).

The inputs to obtain an expression for PPs, are a complex predicate [symbol] and a set [symbol] of trained PPs, each of which corresponds to some simple clause; e.g., [symbol] ={PPₚ}. The goal is to obtain expressions [symbol] that are conjunctions or disjunctions of the PPs in [symbol] which are implied by [symbol] ; e.g., [symbol] ⇒ [symbol] .

If there are m PPs (| [symbol] |=m) and n of the PPs directly match some clauses in a Conjunctive Normal Form (CNF) representation of [symbol] , then there are at least 2″ choices for [symbol] . Since this problem has exponential-sized output, it will require exponential time.

A greedy solution is presented that is based on the intuition that expressions with many PPs will have higher execution costs. Filters that have a high cost should have a relatively larger data reduction in order to perform better than the baseline plan. The input query predicate is sent to a wrangler which greedily improves matchability with available PPs. Examples of the wrangling rules include transforming a not-equal check into disjunctions of equal checks (e.g., t≠2⇒t>2∨t<2) or relaxing a comparison check (e.g., t<5⇒t<10).

Afterward, predicates are converted to expressions over PPs, as illustrated in FIG. 7. For a predicate [symbol] , let [symbol] /p denote the remainder of the [symbol] after removing a simple clause p. The following rules may then be used to generate expressions over PPs.

p∧( [symbol] \p)⇒PPₚ Rule R1:

PP_{p∧q}=PPₚ∧PP_{q} Rule R2:

PP_{p∨q}⇒PPₚ∨PP_{q} Rule R3:

p∧( [symbol] \p)⇒¬PP_{¬p} Rule R4:

Rule R4 may be used for predicates with high selectivity. To construct implied logical expressions over PPs, the following operations are used:

(1) Limit the number of different PPs that are in any expression [symbol] to at most a small configurable constant k.

(2) Apply rules R2 and R3 only if the larger clause (e.g., p∨q or p∨q) does not have an available PP in [symbol] or if at least one of the simpler clauses has a PP that performs better (a smaller ratio of cost to data reduction

$$\frac{c}{r [ 1 ]}$$

indicates better performance). Intuitively, this prevents exploring possibilities that are unlikely to perform better.

For the example in FIG. 7, assuming k=2, the set of available PPs, [symbol] in increasing order of

$$\frac{c}{r [ 1 ]}$$

is {PP_{p∨q}, PPₚ, PP_{p∨¬r}, PP_{q∧¬r}, PP_{q}, PP_{¬r}}. The algorithm may output three possibilities: { [symbol] }={PP_{p∧q}, PP_{¬r}, PP_{p∧¬r}∨PP_{qA¬r}}. The other possibilities may be pruned by greedy checks.

FIG. 8 is a table 802 showing the complexity of different PP approaches according to dimension-reduction and classifier techniques, for some example embodiments. The table 802 describes some of the approaches for dimension reduction in classifier selection, their space complexity, their computational complexity, and their applicability for different cases.

In table 802, n is the number of data items in the (sampled) training set; d (dᵣ) is the number of dimensions in vector x (that remain after dimensionality reduction): n′ is the number of neighbor nodes in the k-d tree; dₘ is the number of parameters in the DNN model; b is the number of epochs; and c_{ƒ}(c_{b}) is the forward (backward) propagation cost. In all cases, dᵣ<<n is assumed.

Techniques are provided for constructing PPs and for performing dimension reduction, all of which could be used with or without sampling the training data and with several parameter choices (e.g., number of reduced dimensions dᵣ for FH). This leads to many possible techniques for PPs. It is important to determine quickly which technique is the most appropriate for a given input dataset.

Given different PP methods [symbol] , the best approach m is selected by maximizing the reduction rate rₘ for the following approach:

$$m = arg {r}_{m} [ a ] \qquad ( 11 )$$

Furthermore, these methods have different applicability constraints as summarized in the table 802. First, [symbol] may be pruned using these applicability constraints. To compute rₘ[a] quickly, a sample of the training data is used and a fixed at 0.95. Further, a few different simple clauses are chosen randomly, the classifiers are trained, and then the technique that performs better is used. Experiments show that the input dataset has the strongest influence on technique choice; that is, given a certain type of input blobs, the same PP technique is appropriate for different predicates and accuracy thresholds.

FIG. 9 illustrates the functionality of PP classifiers trained using a linear support vector machine or a kernel density estimator, according to some example embodiments. In some example embodiments, the PP is an SVM-type classifier. There are items belonging to two classes: the first class represented by white circles 904 for −1 and the second class represented by dark circles 910 for +1.

The classifier is configured to identify the separation between the items of the first class and the items of the second class. A separation line 908 identifies the two subspaces for classifying items. In some example embodiments, a KDE-based PP measures ƒ_{kde}(x) as d⁺(x)/d⁻(x), where d is estimated based on a neighborhood 906 of h. Density functions 912 and 914 illustrate the densities for the first class and the second class.

FIG. 10 illustrates the generation of threshold values based on accuracy levels, according to some example embodiments. The threshold is the minimum possible value of (x) that provides the required accuracy on the training or the test set. Values larger than the threshold will provide the same or better accuracy.

FIG. 10 illustrates data rows ranked in ascending order according to their ƒ(x) values. As in FIG. 9, the dark circles 910 and the white circles 904 represent data blobs with +1 and −1 labels respectively. The threshold th[a] is selected to be the largest threshold value that correctly identifies an a portion of the +1 data points represented by the dark circles 910.

In this example, th₁ represents 100% accuracy because all of the dark circles 910 are captured to the right of th₁ Further, th_{0.9} is the threshold for 90/% accuracy, because 90% of the dark circles 910 are to the right of th_{0.9}, etc.

At training time, an array of thresholds th[a] is calculated, as discussed above with reference to equation (5) for different values of a, the desired accuracy. By calculating this array of thresholds th[a] it is possible to choose PPs based on the accuracy required at query optimization time, that is, based on the accuracy specified with the query.

If only one PP is selected, the accuracy directly defines the threshold target. However, when multiple PPs are selected, a decision has to be made about how to distribute the target accuracy for each of the selected PPs.

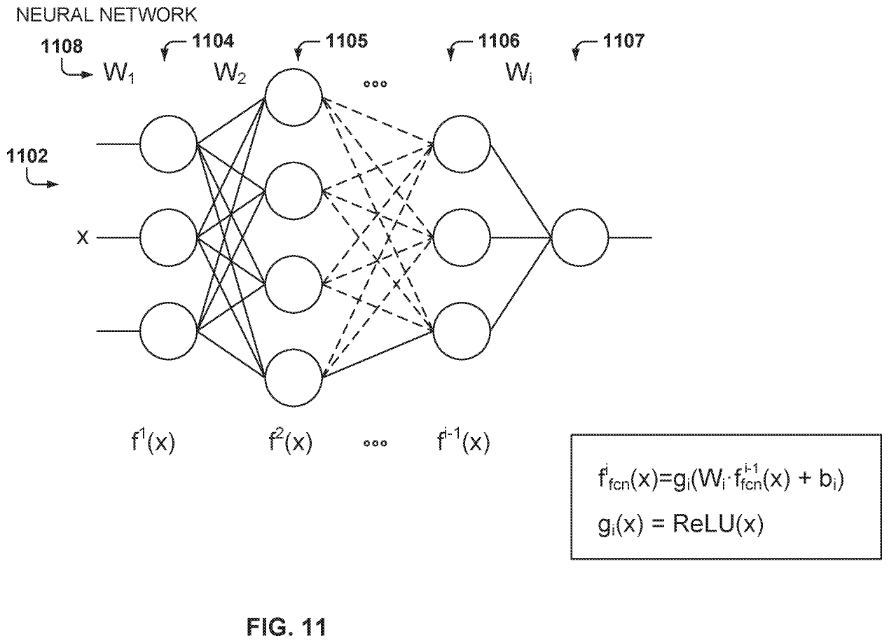

FIG. 11 illustrates the structure of a fully connected neural network based PP classifier, according to some example embodiments. In some example embodiments, the PP may be a neural network classifier 1102.

A neural network, sometimes referred to as an artificial neural network, is a computing system based on consideration of biological neural networks of animal brains. Such systems are trained over a set of example inputs to improve performance, which is referred to as learning. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, which either amplify or dampen the significance of each input for the task that the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

The neural network classifier 1102 can have multiple fully connected layers (e.g., 1104-1107) interpreted as multiplying an input blob x with different weight matrices 1108 sequentially. The function gᵢ (implemented as ReLU, sigmoid, or other) is a non-linear activation applied after each fully connected layer, introducing non-linearity to the model.

The PP design can incorporate any classifier that can be cast as a real-valued function with a threshold (e.g., fin equation (4)). The applicability of the classifier depends on the data distribution, predicates, and classifier costs. In particular, DNNs also fit this requirement, and DNN PPs may be built using ƒ_{ƒcn} in equations (4)-(6), where ƒ_{ƒcn} is calculated as follows:

ƒ_{ƒcn}ⁱ=gᵢ(Wᵢ·ƒ_{ƒcn}ⁱ⁻¹(x)+bᵢ) (12)

DNNs have shown promising classification performance in various ML applications. However, the number of parameters to train DNNs is much larger (e.g., weight matrices) than the number to train the other classifiers previously presented. Hence, training a DNN utilizes more data, and the training cost is significant. Moreover, the execution cost of a PP that uses a DNN can be considerable. Hence, in practice, PPs built using DNNs are appropriate for queries and predicates that have very expensive UDFs (e.g., a much larger DNN), have a large training corpus, or are used so frequently that the higher training cost is justified.

In practice, input blobs may have many dimensions. For example, in videos, each pixel in a frame or an 8×8 patch of pixels can be construed as a dimension. In a bag-of-words representation of natural-language text, each distinct word is a dimension, and the vector x, for a document, is the frequency of the words. When the dimensionality increases, the Euclidean distances used to compute w·x and x−xᵢ lose discriminative power. In some example embodiments, to address this concern, dimension-reduction techniques are applied before the classifier. However, this is optional for some implementations; e.g., ψ(x) can be equal to x.

FIG. 12 shows the query plan for an OR operation over two PP classifiers, according to some example embodiments. Given a set of expressions {E} that are conjunctions or disjunctions of PPs, one goal is to compute the lowest-cost query plan which meets the query's accuracy threshold. If some execution plan for [symbol] has a per-blob cost of c and a reduction-vs-accuracy of r[a], then the query plan cost is proportional to c+(1−r[a])*u, where u is the cost per blob of executing the original query. Further, u and a are inputs to the algorithm, but c and r[a] have to be computed.

Since the order in which the PPs in [symbol] execute and how the accuracy budget is allocated among the individual PPs affect the plan cost, three sub-problems are identified. First, the different allocations of the query's accuracy budget to individual PPs have to be calculated. Second, different orderings of PPs may be explored, within a conjunction or disjunction. This process does a recursion for nested conjunctions or disjunctions. Third, after fixing both the accuracy thresholds and the order of PPs, the cost and reduction rate of the resulting plan have to be computed.

The first sub-problem translates to a dynamic program. For the second sub-problem, it is to be noted that there are at most k PPs in any [symbol] . If k is small, then many orderings can be explored. On the other hand, when k is large, the following heuristic method is utilized: the PPs are ordered based on their ratio of c/r[1], and then the PPs that are an edit-distance of at most 2 away from this greedy order are considered. The edit distance from a first sequence to a second sequence refers to the number of edits, by swapping two elements, that are made to the first sequence to obtain the second sequence. For example, given a greedy order of {p, q, r} for an expression with three PPs in a conjunction or a disjunction, the following orders are an edit distance of 1 away: {p, r, q}, {q, p, r}, and {r, q, p}. Each of the orders, with the edit distance of 1, swap one pair of PPs, i.e., they do one edit to the greedy order. In practice, these types of orderings are proven most useful.

The third sub-problem, computing cost and reduction rate given a fixed PP order and fixed accuracy thresholds, may be solved inductively as follows. In the base case of a single PP, [symbol] =PPₚ, and the cost and accuracy vs. data reduction curve of [symbol] is the same as that of PPₚ.

Further, the disjunction case ( [symbol] = [symbol] ₁∨ [symbol] ₂) is illustrated in FIG. 12, where the costs of the respective logical expressions are c₁ and c₂; their accuracy vs. data reduction curves are r₁[a] and r₂[a]; and the assigned accuracy thresholds are a₁ and a₂, respectively. In this example, for simplicity, an assumption is made that PPₚ 1202 and PP_{q} 1212 are independent; e.g., their respective filters are independent of each other.

For the disjunction case, the following equations are provided:

a=a₁+a₂−a₁*a₂ (13)

r[a]=r₁[a₁]*r₂[a₂] (14)

c[a]=min(c₁+r₁[a₁]*c₂, c₂+r₂[a]*c₁) (15)

For example, if the query requests 99% accuracy, the values of a₁ and a₂ have to combine to obtain the overall a of 99%, and that choice is solved by this optimization.

The following principles may be used: (1) accuracy reduces multiplicatively; (2) the data reduction ratio improves, but the marginal improvement is less, when many PPs are used and if the individual sub-expressions are already highly reductive (e.g., if two expressions each have a reduction rate of 0.1, the conjunction nearly doubles the data reduction to 0.19; however, when each reduction rate is 0.8, the conjunction only increases to 0.96); and (3) the cumulative cost is smaller when the sub-expression with the smaller ratio of c/r[a] executes first. The heuristic algorithm utilized to combine PPs is based on these principles.

If PPₚ 1202 is selected to execute first, the outputs that meet the filtering criteria of PPₚ 1202, shown as a “+”, do not have to be run through PP_{q}1212 because of the nature of the OR operation. Further, the outputs of PPₚ 1202 that do not meet the filtering criteria, shown as a “−”, are the inputs for PP_{q} 1212.

The “+” outputs of PP_{q} 1212 are added 1204 with the “+” outputs of PPₚ 1202, and the result is used as input for the rest of the query 1206. The predicate p∨q is executed 1208 and the result is output 1210. The “−” results of PP_{q} 1212 are discarded 1214 since they do not meet any of the conditions.

FIG. 13 shows the query plan for an AND operation over two PP classifiers, according to some example embodiments. For the conjunction case, [symbol] = [symbol] ₁∧ [symbol] ₂. The following equations apply:

a=a₁*a₂ (16)

r[a]=r₁[a₁]+r₂[a₂]−r₁[a₁]*r₂[a₂] (17)

c[a]=min(c₁+(1−r₁[a₁])*c₂, c₂+(1−r₂[a₂])*c₁) (18)

Due to the nature of the AND operation, the “+” results of PPₚ 1202 are input to PP_{q} 1212, and the “+” results of PP_{q} 1212 are sent to execute the rest of the query 1302. The “−” results of PPₚ 1202 and PP_{q} 1212 are discarded 1308. The predicate p∧q is executed 1304 and the result is output 1306.

One problem to solve is how to determine the optimal choices of PPs to train. For example, given a query set and a constraint on the overall training budget, let us consider the problem of choosing which PPs to train so as to obtain the best possible speed-up over that query set. Let TrainCost_{PP}_{ₚ} be the cost to train PPₚ. The PP for predicate p will help any query q for which p is a necessary condition.

Let Queries_{PP}_{ₚ} be the set of queries that will benefit if PPₚ is trained. For each query q in this set, rₚ[a]^{q} denotes the data reduction rate achieved by using PPₚ on query q while ensuring accuracy is above a. Additionally, a query can use more than one PP. Thus, given a set of available PPs [symbol] , let rₚ[a]^{q} be the best data reduction achieved by q through some combination of PPs in [symbol] . Further, Q is the set of given queries, [symbol] is the set of all predicates in Q (as well as all necessary conditions of those predicates), and T is the training budget. This problem may be formulated as follows:

$${max}_{𝒫 ⊆ 𝒮} ( {\sum }_{q ∈ Q} {{r}_{𝒫} [ a ]}^{q} ) s . t . , {\sum }_{p ∈ 𝒫} {TrainCost}_{{PP}_{p}} \leq T \qquad ( 19 )$$

It is proven herein that this problem is non-deterministic polynomial-time hard (NP-hard) by reducing set cover to a simple version of the above problem. Given a set of elements {1, 2, . . . , n} (referred to as the universe) and a collection S of m sets whose union equals the universe, the set cover problem is to identify the smallest sub-collection of S whose union equals the universe.

The reduction proceeds by creating a query for each element in the universe and a predicate corresponding to each set in S with the understanding that training a PP for this predicate will help all the queries whose elements belong to that set. Hence, the cost of training every PP is set to be the same, and the reduction rates are set to be a unit; that is, a query will receive the maximum benefit if it is covered by at least one PP. It is to be noted that the maximum achievable benefit to these queries will be obtained only when the union of the chosen sub-collection of sets equals the universe. To find the smallest possible sub-collection of S, the training budget may be varied from 1 to |S|=m, and the smallest training budget is found at which the total benefit equals n.

Another task is to determine the optimal use of available PPs: given a set of available PPs [symbol] , the problem is finding a combination of PPs that offers the best data reduction for a query q given an accuracy target a. Further, cₚ is the cost and rₚ[a] is the data reduction rate for a PPp∈ [symbol] . It can be shown that this problem is also NP-hard by reducing the knapsack problem to a very simple version of the above problem, as proven here. The knapsack problem is a resource-allocation problem in combinatorial optimization, where given a set of items, each with a weight and a value, the goal is to determine the number of each item to include in a collection so that the total weight is less than or equal to a given limit and the total value is as large as possible. The knapsack problem derives its name from the problem faced by someone who is constrained by a fixed-size knapsack and must fill it with the most valuable items.

For the purpose of this reduction, it may be assumed that only conjunctions of the available PPs are allowed. Furthermore, the above problem has two parts: how to apportion the accuracy budget among the available PPs and how to order the chosen PPs. Leaving aside the ordering of PPs, the reduction begins by associating, with each item, a corresponding PP whose reduction rate is equal to the value of the item if the accuracy budget apportioned to this PP is, at most, the log of the weight of the item, and zero otherwise. That is, the PP will offer a reduction rate (value) only if given at least that much accuracy budget (weight). Further, the log of the limit is set as the accuracy budget and the sum of logs is the product of individual accuracy budgets as per the conjunction PP formula (equation (17)). It is easy to see that the optimal PP choice is akin to packing a 0-1 knapsack (each PP is picked or not picked) to achieve the largest value (reduction rate) while total weight (product of accuracy values) remains within the budget (query's accuracy target).

Further, additional rules are defined for complex predicates. The goal is to determine predicate clauses so that the predicate clauses can be exactly matched to PPs.
Not-equals check (ƒ(C)≠v): if the range of ƒ(C) is finite and discrete, then ƒ(C)≠v⇒V_{t∈Range(ƒ(C))/v}ƒ(C)=t. For example, if vehicle type ∈ {SUV, truck, car}, then type≠SUV⇒type=truck∨type=car. This wrangling is useful if PPs exist only for the clauses truck and car.
Comparison: ƒ(C)>v⇒ƒ(c)>t, ℄t≤v. The expression on the right side of the equation relaxes the comparison and may be useful if a PP has been trained for some value t. Another rewrite is possible when ƒ(C) is finite and discrete, such as ƒ(C)>v⇒V_{t∈Range(ƒ(C)); t<v} ƒ(C)=t. Similar rewrites are available for other operations, such as >, ≤, ≥.
Range-check (v₁≤ƒ(C)≤v₂) is a special case of comparison which is bounded on both sides and can be wrangled as above.
No-predicate: If some column set C in the query output has a finite and discrete range, even a query with no predicate can benefit from PPs because 1⇔V_{t∈Range(C)}C=t. For the above example of vehicle type, 1⇔(type=car)∨(type=truck)∨(type=SUV).

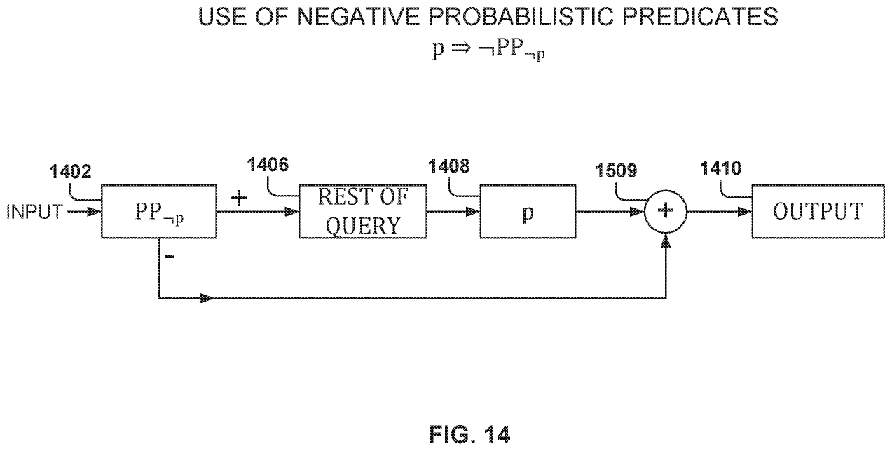

FIG. 14 illustrates an example of the use of a negative PP. As discussed above, the predicate rewrite rule R4 is: p∧( [symbol] \p)⇒¬PP_{¬p}. To evaluate p, if PP_{¬p} 1402 is available it may be used by executing PP_{¬p} 1402 and using the “+” results as input to the rest of the query 1406. After p is performed 1408 by the database, the results are added 1509 to the “-” outputs of PP_{¬p} 1402 to obtain the output 1410.

This rule is powerful because predicates that have high selectivity will not yield useful PPs but their negations can achieve substantial data reductions. As shown in FIG. 14, blobs that fail the negative PP are output immediately. This requires that the schema of the query output match the schema of the query input, e.g., that the query be simply selecting a subset of blobs. Further, the rule may compose in a complex way with the other rules because its application may lead to false positives.

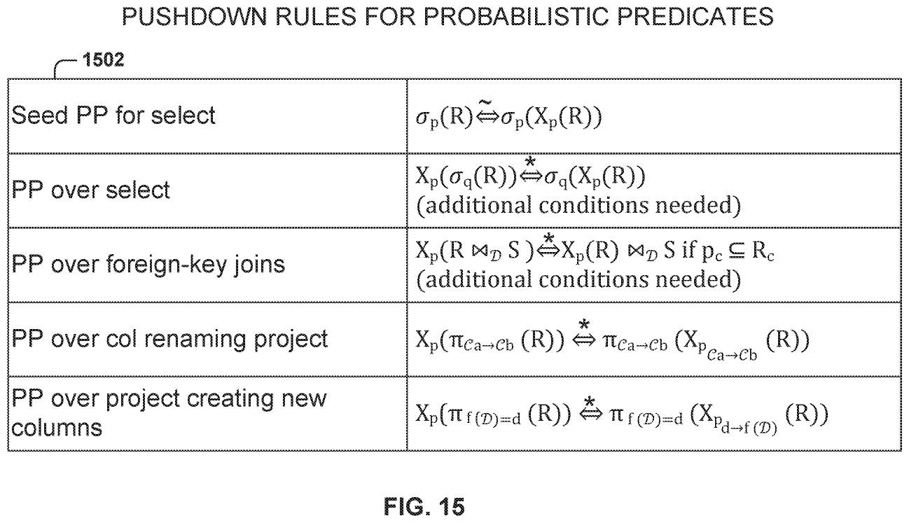

FIG. 15 is a table 1502 showing pushdown rules for PPs, according to some example embodiments. A placeholder, denoted Xₚ, is used to seed a possible PP, and the method attempts to push the placeholder down using these rules until Xₚ executes directly on the raw input.

It is to be noted that predicates on a raw input can possibly be replaced with some combination of PPs. If this is not possible, the placeholder is simply omitted by the QO from the final plan. In the first rule, the expression on the right is less accurate, e.g., it has a given number of false positives and false negatives. For each subsequent rule, the expressions have equivalent accuracy, but the one on the right can offer better performance.

Further, some rules hold only under certain conditions. The pushing down requires that the predicates p and q be independent. Further, for the foreign-key join rule, R and S are rowsets being equijoined on columnset [symbol] , which is a primary key for S and a foreign key for R. This rule holds if the selection performed implicitly by the foreign-key join (note that each row from R contributes at most one row to the join output) is independent of the predicate p. Furthermore, the pushdown rules for project change the columns in the predicate to invert the effect of the projection.

As a further explanation on dependent predicates, reasonable performance has been observed during experimentation for queries with multiple PPs. However, if the PPs upon multiple predicate columns are dependent, the cost and reduction rate estimation, and therefore the PP planning, will be suboptimal. In such cases, a runtime fix is applied. If it is observed that the PP cost and reduction rate at runtime differ dramatically from their estimations, such predicates are flagged as possibly dependent so that the QO will only use one PP (and not a combination of dependent PPs) in the future for that predicate. It is also to be noted that because practical accuracy targets are very close to 1, the independence assumption may be replaced with a high upper bound accuracy limit.

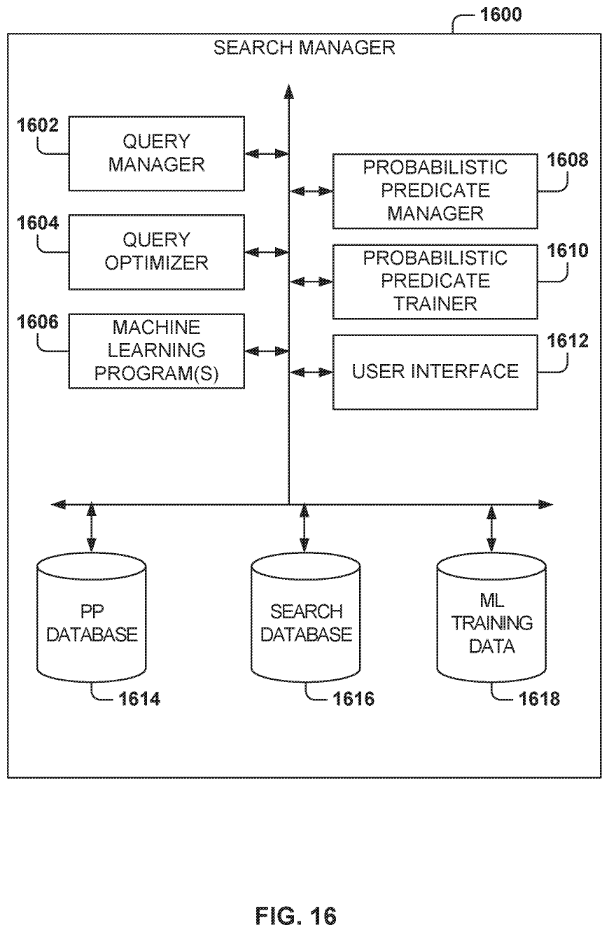

FIG. 16 illustrates a search manager 1600 for implementing example embodiments. The search manager 1600 includes a query manager 1602, a query optimizer 1604, machine learning programs 1606, a probabilistic predicate manager 1608, a probabilistic predicate trainer 1610, a user interface 1612, and a plurality of databases. The databases include, at least, a PP database 1614, a search database 1616, and an ML training data database 1618.

The query manager 1602 manages the queries received in the system, such as via the user interface 1612, and interacts with the other elements to determine the processing of the received query. The query optimizer 1604 performs the operations described above for optimizing queries and creating an implementation plan. The machine learning programs 1606 include some of the classifiers described hereinabove.

Further, the probabilistic predicate manager 1608 manages the creation and evaluation of PPs, and the probabilistic predicate trainer 1610 performs the training for the selected PPs.

The PP database 1614 stores a plurality of trained PPs for use in processing queries. The search database 1616 includes the input data that is being searched, such as images from cameras throughout a city. Further, the ML training data database 1618 stores the data used for training the different classifiers.

It is to be noted that the embodiments illustrated in FIG. 16 are examples and do not describe every possible embodiment. Other embodiments may utilize different modules, utilize additional modules, or combine functionality. The embodiments illustrated in FIG. 16 should therefore not be interpreted to be exclusive or limiting, but rather illustrative.

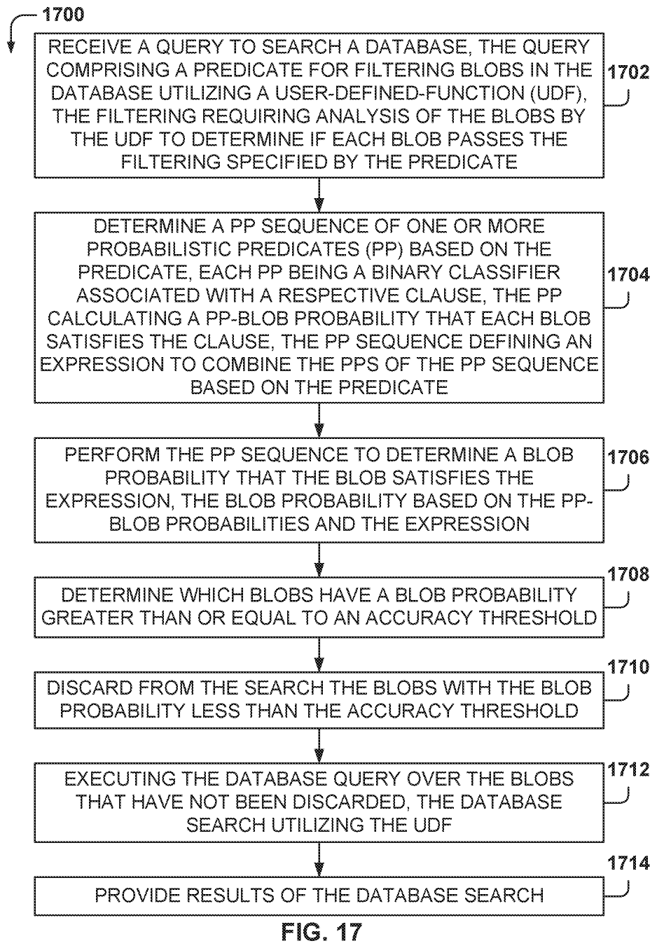

FIG. 17 is a flowchart of a method 1700 for utilizing probabilistic predicates to speed up searches that utilize machine learning inferences, according to some example embodiments. While the various operations in this flowchart are presented and described sequentially, one of ordinary skill will appreciate that some or all of the operations may be executed in a different order, be combined or omitted, or be executed in parallel.

At operation 1702, a query to search a database is received, the query comprising a predicate for filtering blobs in the database utilizing a user-defined-function (UDF), the filtering requiring analysis of the blobs by the UDF to determine if each blob passes the filtering specified by the predicate.

From operation 1702, the method 1700 flows to operation 1704 for determining a PP sequence of one or more probabilistic predicates (PP) based on the predicate, each PP being a binary classifier associated with a respective clause, the PP calculating a PP-blob probability that each blob satisfies the clause, the PP sequence defining an expression to combine the PPs of the PP sequence based on the predicate.

From operation 1704, the method 1700 flows to operation 1706 for performing the PP sequence to determine a blob probability that the blob satisfies the expression, the blob probability based on the PP-blob probabilities and the expression.

From operation 1706, the method 1700 flows to operation 1708 for determining which blobs have a blob probability greater than or equal to an accuracy threshold.

From operation 1708, the method 1700 flows to operation 1710 for discarding from the search the blobs with the blob probability less than the accuracy threshold.

At operation 1712, the database query is executed over the blobs that have not been discarded, the database search utilizing the UDF, and at operation 1714, the results of the database search are provided.

In some example embodiments, the operations of the method 1700 are performed by one or more processors.

In one example, the blob is an image, where each PP performs a binary classification to determine if the image of the blob meets the clause of the PP.

In one example, the query includes the accuracy threshold, where each PP is associate with a PP accuracy, cost of executing the PP, and a reduction rate.

In one example, determining the PP sequence further includes: selecting PPs, from an available pool of PPs, based on the accuracy threshold in the query and the cost, PP accuracy, and reduction rates of PPs in the available pool of PPs.

In one example, the expression includes a logical OR operation of a first clause of a first PP and a second clause of a second PP, wherein performing the PP sequence further includes: executing the first PP to generate a set of first passing blobs that meet the first clause and a set of first failing blobs that do not meet the first clause; executing the second PP on the set of first failing blobs to generate a set of second passing blobs that meet the second clause and a set of second failing blobs that do not meet the second clause; and continuing the PP sequence with a union of the set of first passing blobs and the set of second passing blobs.

In one example, the expression includes a logical AND operation of a third clause of a third PP and a fourth clause of a fourth PP, wherein performing the PP sequence further includes: executing the third PP to generate a set of third passing blobs that meet the third clause and a set of third failing blobs that do not meet the third clause; executing the fourth PP on the set of third passing blobs to generate a set of fourth passing blobs that meet the fourth clause and a set of fourth failing blobs that do not meet the fourth clause; and continuing the PP sequence with the set of fourth passing blobs.

In one example, the expression includes a logical NOT operation of a fifth clause, wherein determining the PP sequence further includes selecting between executing a fifth PP associated with the fifth clause or executing a sixth PP associated with a clause that is a logical NOT of the fifth clause.

In one example, the method 1700 further includes: analyzing queries received to search the database; selecting PPs based on the analyzed queries; and training the selected PPs.

In one example, the UDF includes one or more feature extractors and one or more classifiers, where each PP operates on the blobs in the database without using the feature extractors and the classifiers of the UDF.

In one example, each PP is a neural network trained with labeled data for a plurality of training blobs.

Experiments have shown that running online/batch machine learning inference with PPs achieves as much as ten times speed-up with different predicates compared with executing the queries as-is.

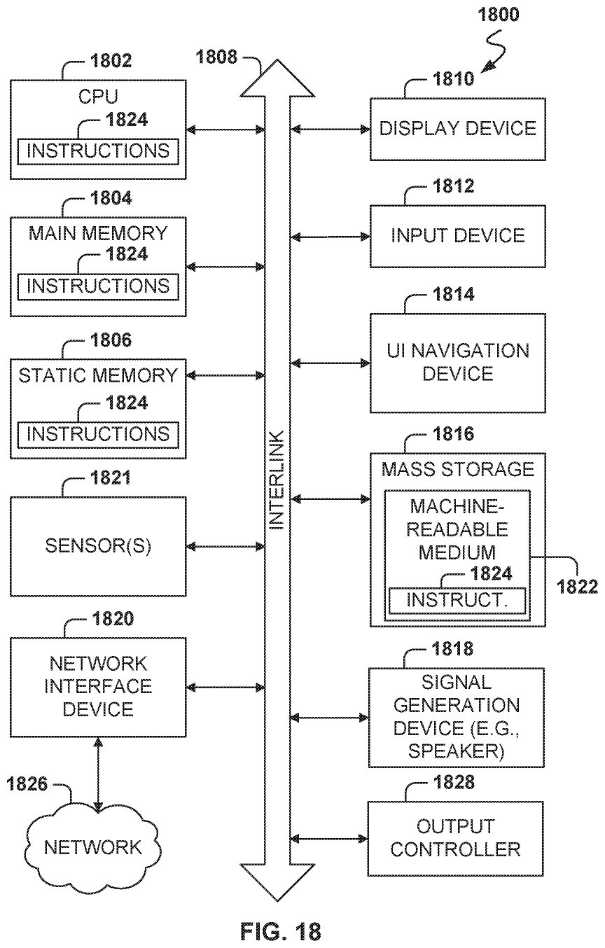

FIG. 18 is a block diagram illustrating an example of a machine 1800 upon or by which one or more example process embodiments described herein may be implemented. In alternative embodiments, the machine 1800 may operate as a standalone device or may be connected (e.g., networked) to other machines. In a networked deployment, the machine 1800 may operate in the capacity of a server machine, a client machine, or both in server-client network environments. In an example, the machine 1800 may act as a peer machine in peer-to-peer (P2P) (or other distributed) network environment. The machine 1800 may be a personal computer (PC), a tablet PC, a set-top box (STB), a laptop, a mobile telephone, a web appliance, a network router, a network switch, a network bridge, or any machine capable of executing instructions (sequential or otherwise) that specify actions to be taken by that machine. Further, while only a single machine 1800 is illustrated, the term “machine” shall also be taken to include any collection of machines that individually or jointly execute a set (or multiple sets) of instructions to perform any one or more of the methodologies discussed herein, such as by cloud computing, software as a service (SaaS), or other computer cluster configurations.

Examples, as described herein, may include, or may operate by, logic or a number of components or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1800 may include a Central Processing Unit (CPU) 1802, a main memory 1804, and a static memory 1806, some or all of which may communicate with each other via an interlink (e.g., bus) 1808. The machine 1800 may further include a display device 1810, one or more input devices 1812 (e.g., a keyboard, a microphone, a touchscreen, a game controller, a remote control, a camera, dedicated buttons), and one or more user interface navigation devices 1814 (e.g., a mouse, a touchpad, a touchscreen, a joystick, a gaze tracker). In an example, the display device 1810, input devices 1812, and user interface navigation devices 1814 may include a touchscreen display. The machine 1800 may additionally include a mass storage device (e.g., drive unit) 1816, a signal generation device 1818 (e.g., a speaker), a network interface device 1820, and one or more sensors 1821, such as a Global Positioning System (GPS) sensor, compass, accelerometer, magnetometer, or other sensors. The machine 1800 may include an output controller 1828, such as a serial (e.g., universal serial bus (USB)), parallel, or other wired or wireless (e.g., infrared (IR), near field communication (NFC), etc.) connection to communicate with or control one or more peripheral devices (e.g., a printer, a card reader, etc.).

The mass storage device 1816 may include a machine-readable medium 1822 on which is stored one or more sets of data structures or instructions 1824 (e.g., software) embodying or utilized by any one or more of the techniques or functions described herein. The instructions 1824 may also reside, completely or at least partially, within the main memory 1804, within the static memory 1806, or within the CPU 1802 during execution thereof by the machine 1800. In an example, one or any combination of the CPU 1802, the main memory 1804, the static memory 1806, or the mass storage device 1816 may constitute machine-readable media.

While the machine-readable medium 1822 is illustrated as a single medium, the term “machine-readable medium” may include a single medium or multiple media (e.g., a centralized or distributed database, and/or associated caches and servers) configured to store the one or more instructions 1824. A storage medium is not a transitory propagating signal.

The term “machine-readable medium” may include any medium that is capable of storing, encoding, or carrying instructions 1824 for execution by the machine 1800 and that cause the machine 1800 to perform any one or more of the techniques of the present disclosure, or that is capable of storing, encoding, or carrying data structures used by or associated with such instructions 1824. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1824 may further be transmitted or received over a communications network 1826 using a transmission medium via the network interface device 1820.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a query to search a database, the query comprising a predicate for filtering blobs in the database utilizing a user-defined-function (UDF), the filtering requiring analysis of the blobs by the UDF to determine if the blobs pass the filtering specified by the predicate;
determining a PP sequence of one or more probabilistic predicates (PP) based on the predicate, each PP being a binary classifier associated with a respective clause, the PP calculating a PP-blob probability that each blob satisfies the clause, the PP sequence defining an expression to combine the PPs of the PP sequence based on the predicate;
performing the PP sequence to determine a blob probability that the blob satisfies the expression, the blob probability based on the PP-blob probabilities and the expression;
determining which blobs have a blob probability greater than or equal to an accuracy threshold;
discarding, from the search, the blobs with the blob probability less than the accuracy threshold;
executing the database query over the blobs that have not been discarded, the database search utilizing the UDF; and
providing results of the database search.

2. The method as recited in claim 1, wherein the blob is one of an image, a video, or a text document, wherein each PP performs a binary classification to determine if the blob meets the clause of the PP.

3. The method as recited in claim 1, wherein the query includes the accuracy threshold, wherein each PP is associated with a PP accuracy, cost of executing the PP, and a reduction rate.

4. The method as recited in claim 3, wherein determining the PP sequence further includes:
selecting PPs, from an available pool of PPs, based on: the accuracy threshold in the query and the cost, PP accuracy, and reduction rates of PPs in the available pool of PPs.

5. The method as recited in claim 1, wherein the expression includes a logical OR operation of a first clause of a first PP and a second clause of a second PP, wherein performing the PP sequence further includes:
executing the first PP to generate a first set of passing blobs that meet the first clause and a first set of failing blobs that do not meet the first clause;
executing the second PP on the first set of failing blobs to generate a second set of passing blobs that meet the second clause and a second set of failing blobs that do not meet the second clause; and
continuing the PP sequence with a union of the first set of passing blobs and the second set of passing blobs.

6. The method as recited in claim 1, wherein the expression includes a logical AND operation of a third clause of a third PP and a fourth clause of a fourth PP, wherein performing the PP sequence further includes:
executing the third PP to generate a third set of passing blobs that meet the third clause and a third set of failing blobs that do not meet the third clause;
executing the fourth PP on the third set of passing blobs to generate a fourth set of passing blobs that meet the fourth clause and a fourth set of failing blobs that do not meet the fourth clause; and
continuing the PP sequence with the fourth set of passing blobs.

7. The method as recited in claim 1, wherein the expression includes a logical NOT operation of a fifth clause, wherein determining the PP sequence further includes:
selecting between executing a fifth PP associated with the fifth clause or executing a sixth PP associated with a clause that is a logical NOT of the fifth clause.

8. The method as recited in claim 1, further comprising:
analyzing queries received to search the database;
selecting PPs based on the analyzed queries; and
training the selected PPs.

9. The method as recited in claim 1, wherein the UDF includes one or more feature extractors and one or more classifiers, wherein each PP operates on the blobs in the database without using the feature extractors and the classifiers of the UDF.

10. The method as recited in claim 1, wherein each PP is a classifier trained with labeled data for a plurality of training blobs.

11. A system comprising:
a memory comprising instructions; and
one or more computer processors, wherein the instructions, when executed by the one or more computer processors, cause the one or more computer processors to perform operations comprising:
receiving a query to search a database, the query comprising a predicate for filtering blobs in the database utilizing a user-defined-function (UDF), the filtering requiring analysis of the blobs by the UDF to determine if the blobs pass the filtering specified by the predicate;
determining a PP sequence of one or more probabilistic predicates (PP) based on the predicate, each PP being a binary classifier associated with a respective clause, the PP calculating a PP-blob probability that each blob satisfies the clause, the PP sequence defining an expression to combine the PPs of the PP sequence based on the predicate;
performing the PP sequence to determine a blob probability that the blob satisfies the expression, the blob probability based on the PP-blob probabilities and the expression;
determining which blobs have a blob probability greater than or equal to an accuracy threshold;
discarding, from the search, the blobs with the blob probability less than the accuracy threshold;
executing the database query over the blobs that have not been discarded, the database search utilizing the UDF; and
providing results of the database search.

12. The system as recited in claim 11, wherein the blob is one of an image, a video, or a text document, wherein each PP performs a binary classification to determine if the blob meets the clause of the PP.

13. The system as recited in claim 11, wherein the query includes the accuracy threshold, wherein each PP is associated with a PP accuracy, cost of executing the PP, and a reduction rate.

14. The system as recited in claim 13, wherein determining the PP sequence further includes:
selecting PPs, from an available pool of PPs, based on: the accuracy threshold in the query and the cost, PP accuracy, and reduction rates of PPs in the available pool of PPs.

15. The system as recited in claim 11, wherein the expression includes a logical OR operation of a first clause of a first PP and a second clause of a second PP, wherein performing the PP sequence further includes:
executing the first PP to generate a first set of passing blobs that meet the first clause and a first set of failing blobs that do not meet the first clause;
executing the second PP on the first set of failing blobs to generate a second set of passing blobs that meet the second clause and a second set of failing blobs that do not meet the second clause; and
continuing the PP sequence with a union of the first set of passing blobs and the second set of passing blobs.

16. A non-transitory machine-readable storage medium including instructions that, when executed by a machine, cause the machine to perform operations comprising:
receiving a query to search a database, the query comprising a predicate for filtering blobs in the database utilizing a user-defined-function (UDF), the filtering requiring analysis of the blobs by the UDF to determine if the blobs pass the filtering specified by the predicate;
determining a PP sequence of one or more probabilistic predicates (PP) based on the predicate, each PP being a binary classifier associated with a respective clause, the PP calculating a PP-blob probability that each blob satisfies the clause, the PP sequence defining an expression to combine the PPs of the PP sequence based on the predicate;
performing the PP sequence to determine a blob probability that the blob satisfies the expression, the blob probability based on the PP-blob probabilities and the expression;
determining which blobs have a blob probability greater than or equal to an accuracy threshold;
discarding, from the search, the blobs with the blob probability less than the accuracy threshold;
executing the database query over the blobs that have not been discarded, the database search utilizing the UDF; and
providing results of the database search.

17. The non-transitory machine-readable storage medium as recited in claim 16, wherein the blob is one of an image, a video, or a text document, wherein each PP performs a binary classification to determine if the blob meets the clause of the PP.

18. The non-transitory machine-readable storage medium as recited in claim 16, wherein the query includes the accuracy threshold, wherein each PP is associated with a PP accuracy, cost of executing the PP, and a reduction rate.

19. The non-transitory machine-readable storage medium as recited in claim 18, wherein determining the PP sequence further includes:
selecting PPs, from an available pool of PPs, based on: the accuracy threshold in the query and the cost, PP accuracy, and reduction rates of PPs in the available pool of PPs.

20. The non-transitory machine-readable storage medium as recited in claim 16, wherein the expression includes a logical OR operation of a first clause of a first PP and a second clause of a second PP, wherein performing the PP sequence further includes:
executing the first PP to generate a set of first passing blobs that meet the first clause and a set of first failing blobs that do not meet the first clause;
executing the second PP on the set of first failing blobs to generate a set of second passing blobs that meet the second clause and a set of second failing blobs that do not meet the second clause; and
continuing the PP sequence with a union of the set of first passing blobs and the set of second passing blobs.
